(19) United States
(12) Patent Application Publication
(10) Pub. No.: US 2025/0286815 A1
(43) Pub. Date: Sep. 11, 2025

(54) Collective Multicast Flow-Zone Switching

(71) Applicant: Roger B. Marks, Denver, CO (US)

(72) Inventor: Roger B. Marks, Denver, CO (US)

(73) Assignee: Consensii LLC, Denver, CO (US)

(21) Appl. No.: 19/075,109

(22) Filed: Mar. 10, 2025

Related U.S. Application Data
(60) Provisional application No. 63/563,350, filed on Mar. 9, 2024.

(51) Int. Cl. H04L 45/00; H04L 45/24

(52) U.S. Cl. CPC H04L 45/66; H04L 45/245

(57) ABSTRACT

A computer data network is efficiently configured to forward multicast frames among a collective of hosts using a tree spanning the collective. The computer network topology may be a tree. It may also be a Clos fat-tree configured for flow-zone switching. Operation of a data switch to support collective multicast operation is disclosed.

### CROSS REFERENCE TO RELATED APPLICATIONS

The present application is related to, and claims the priority benefit of, commonly-assigned and co-pending U.S. Application Ser. No. 63/563,350, entitled “Collective Multicast Flow-Zone Switching,” filed on 9 Mar. 2024, which is incorporated herein by reference in its entirety.

### TECHNICAL FIELD

The present disclosure relates to data switching and addressing, particularly to switching of collective multicast in Clos fat-tree networks with flow-zone switching and in tree networks.

### BACKGROUND ART

Computer networks are used to connect sets of individual computational units, here identified as hosts, wherein a host may include multiple computational elements but is considered a single unit from the perspective of the network. Some communication among hosts is unicast, with a host's transmitted frame addressed to and delivered to a single other host.

Some computational applications operate more efficiently using multicast communication, in which a message from a host is intended for receipt by multiple hosts. A maximal version of multicast is broadcast, in which a message from a host is intended for receipt by all other hosts.

Layer 2 networks, such as those based on Ethernet and other IEEE 802 standards, recognize the need for multicast operations. Frames in such networks are typically delivered to a host according to an address in the frame. A single bit in the address identifies it as a unicast or multicast address. The network's method of delivery of a frame is then dependent on that bit.

For unicast delivery, an address is uniquely assigned to a host, and the network is configured to deliver the frame to the host identified in the frame's destination address. A switch receiving a unicast frame examines the destination address and typically forwards the frame via a single egress port, selected in order to advance the frame toward the destination host. Hosts typically open their receive filter to receive frames addressed to their own unicast addresses.

Multicast operation is more complex than unicast and its optimal implementation depends on the usage model.

Typically, a multicast address identifies an aspect of the frame as transmitted by a host, with the binding between the aspect and the address known to other hosts. Hosts open their receive filter to receive frames addressed to any multicast address corresponding to the aspects in which they are interested.

Such a procedure is consistent with a broadcast delivery by the network, giving each host an opportunity to consider each frame. However, broadcast is inefficient in that it uses bandwidth to deliver frames to branches of the network in which no host desires receipt. A more effective network is configured to deliver frames only along links toward active recipients. This also reduces the filtering burden on hosts and the security risks of unnecessary delivery.

Conventional multicast addressing works similarly to unicast, but the switch determines an egress vector for a frame based on the multicast destination address, in which the egress vector identifies zero or more egress ports used to forward the frame toward its destinations.

In conventional Layer 2 networks, switches are trained to deliver multicast frames only to declared recipients. The standard configuration procedure is known as “Multiple MAC Registration Protocol” (MMRP) and specified in IEEE Standard 802.1Q. Using MMRP, a host declares interest in a multicast address to a neighbor. That interest is passed along to further neighbors until each switch in the entire network associates an egress vector with that multicast destination address.

MMRP implements a usage model, called “Open Host Group” in IEEE Std 802.1Q, in which any host can declare an interest in a multicast address and any host can transmit to any multicast address. Herein, this model is separated into two concepts.

Use of the “open receive” model provides that a host anywhere in the network can declare interest in a multicast address and should receive any frame sent to that address. In some such cases, a source needs no knowledge of the destination hosts.

Use of the “open send” model provides that the network is configured to deliver a message from any host that sends to a declared destination address. This is aligned with the concept that a declaration indicates interest in the destination address, not to the source.

MMRP, in support of the open send model, requires that declarations be propagated throughout the network and stored throughout, so that each switch is prepared to determine an egress vector for any declared multicast address. This requirement demands complexity, communication, and switch memory.

In these models, a host needs to know an aspect of a multicast address in order to correctly declare interest in it. Various mechanisms exist for this purpose. For example, a host may be interested in receiving all multicast frames for a certain application, regardless of source. In this case, the host may be statically configured to declare interest in a known multicast address paired with that application.

Another example is a distribution from a single source. A single host may advertise (by broadcast or multicast, for example) a particular aspect and its intent to transmit frames of that aspect to an identified multicast address. Interested recipients respond by declaring interest in those transmissions, thereby leading to configuration of switches. This concept is used in the Stream Reservation Protocol (SRP) of IEEE 802.1Q.

This method results in some inefficiency. Declarations are carried and stored throughout the network based on the notion of open send (in other words, to prepare for sources throughout the network) even though the model is based on a single transmitting source. One object of the current disclosure is to detail a more efficient process for such a use model.

In such a process, the host need not be aware of the recipients but is typically made aware that at least one declaration is active so that, in the absence of listeners, it may decline to transmit.

Alternative multicast models are in use. For example, a destination zone map in a frame may allow the source to specify a list of destinations, inserting that list into the frame. Switches are then configured to compute an egress vector from the destination zone map. In this model, the source is required to know the destinations; for example, hosts may respond by unicast to the advertisement to inform the source of their interest. Since the list is provided in the frame, no declaration to the network is required.

### OBJECTS OF INVENTION

An object of the current disclosure is to efficiently extend multicast networking to include an additional delivery model, that of collective multicast within a group. A group in this model is a set of hosts that communicate on one or more topics. A multicast address may represent the group and the topic; such an address serves the role of a communicator, a term used in contexts such as the Message Passing Interface (MPI) of the MPI Forum. In this model, hosts use the destination address to identify a multicast communication among themselves only. For example, a collective broadcast is intended for delivery to each member of the collective and not to others.

An object of this disclosure is to detail how collective multicast can be easily implemented in an arbitrary tree network and how it results in efficient communication via a minimal spanning tree connecting the group members, avoiding all interaction with switches outside that minimal spanning tree.

Networks discussed to this point of the disclosure are of arbitrary configuration or arbitrary tree configuration. Many instances of collective communication are in dense computing networks designed for high performance. Often these offer multiple connections between hosts and are therefore not tree structures, so the collective multicast approaches discussed above do not apply. However, such networks are typically structured in such a way that forwarding can be simplified. For example, my earlier patents and patent applications disclose the use of block addressing and flow-zone switching in modified Clos fat-tree networks for efficient unicast frame delivery without forwarding tables in the switches. The present disclosure extends that concept to include collective communication. The approach is similar to that of the tree network but is adapted to the Clos fat-tree network. Again, the approach, except in specific cases, routes collective frames only via the minimal spanning tree connecting them, and no switches outside that tree are affected. This is aligned with the open receive model, with the set of receivers limited to those hosts declaring. The disclosure easily and efficiently allows for an open send model in which any host outside the group can set a message to all members.

### SUMMARY OF INVENTION

According to an aspect of the present invention, a data switch responds to a collective assignment frame by storing or updating an egress vector identifying the ingress and egress ports of the collective assignment frame, subsequently applying that egress frame to the forwarding of a collective multicast frame.

According to another aspect of the present invention, a method of operating a data switch to forward collective multicast frames in a network provides that a switch responds to a collective assignment frame by storing or updating an egress vector identifying the ingress and egress ports of the collective assignment frame, subsequently applying that egress frame to the forwarding of a collective multicast frame.

According to a another aspect of the present invention, a computer program product comprising a non-transitory computer-readable storage medium stores instructions that, when executed by a data switch, configure data switch to forward collective multicast frames in a network provides that a switch responds to a collective assignment frame by storing or updating an egress vector identifying the ingress and egress ports of the collective assignment frame, subsequently applying that egress frame to the forwarding of a collective multicast frame. Other aspects of the disclosure are also described herein.

### BRIEF DESCRIPTION OF DRAWINGS

FIG. 1a illustrates a switch.

FIG. 1b illustrates a forwarding database.

FIG. 2 illustrates a host.

FIG. 3a illustrates an embodiment of host-driven collective multicast in a tree.

FIG. 3b illustrates an embodiment of root-driven collective multicast in a tree.

FIG. 4a illustrates a request-stage embodiment of root-assigned collective multicast configuration in a tree.

FIG. 4b illustrates an assignment-stage embodiment of root-assigned collective multicast configuration in a tree.

FIG. 5 illustrates a k-ary Clos fat-tree with k=2.

FIG. 6 illustrates k-ary Clos fat-tree element enumeration in an embodiment with k=2.

FIG. 7a is a table of host and switch address blocks in an embodiment.

FIG. 7b is a table of host and switch address block identifiers in an embodiment.

FIG. 8 is a flowchart illustrating an embodiment of flow-zone forwarding.

FIG. 9 illustrates collective multicast forwarding in a Clos fat-tree.

FIG. 10 illustrates an embodiment of host-driven collective multicast configuration in a Clos fat-tree.

FIG. 11 is a flowchart illustrating host-driven collective multicast configuration in a Clos fat-tree.

FIG. 12 illustrates an assignment-stage embodiment of spine-assigned collective multicast configuration in Clos fat-tree.

FIG. 13 is a flowchart illustrating an embodiment of spine-assigned collective multicast configuration in a Clos fat-tree.

### DETAILED DESCRIPTION

### Overview

This disclosure teaches the use of collective assignment frames to efficiently configure network switches enabling efficient collective multicast communications.

Various embodiments of the invention will now be described by way of example and with reference to the drawings. However, it should be realized that this is not an exhaustive description of all possible embodiments and that many other embodiments and variations fall within the scope of the appended claims and can be realized by those persons having ordinary skill in the art. Other aspects of the disclosure are also described herein.

### Switch

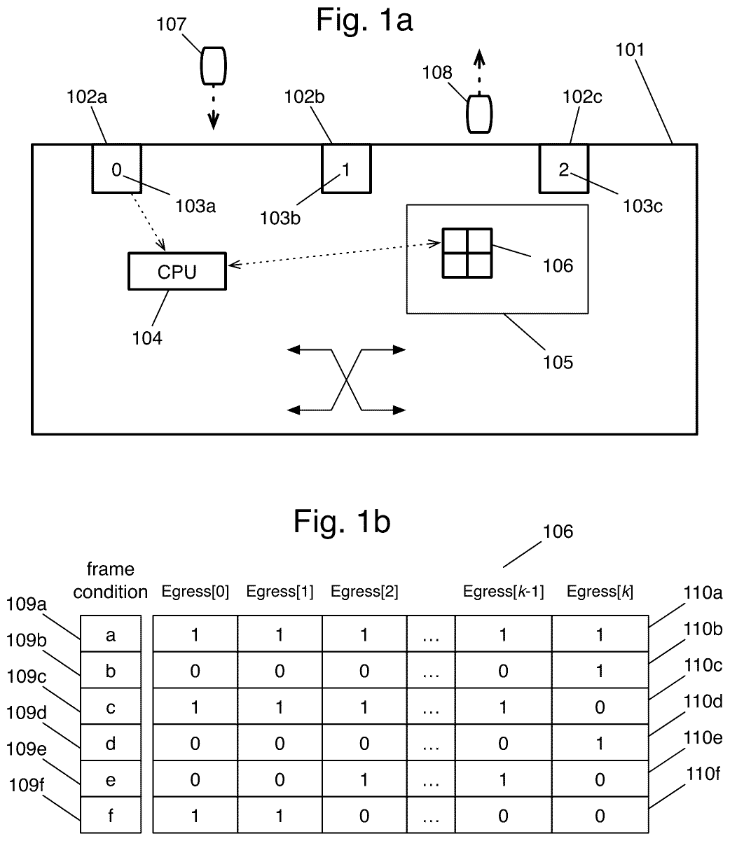

An embodiment of a switch (101) useful in illustrating this disclosure is shown in FIG. 1a. Switch 100 is provided with a plurality of ports (102), three of which (102a, 102b, and 102c) are indicated in the example of FIG. 1a. Each port is associated with a port identifier (port ID) (103), illustrated in FIG. 1a as 103a, 103b, and 103c, respectively. The switch (101) forwards data units, such as Layer 2 data frames (referred to here simply as frames). In the embodiment, each port is enabled to receive an ingress frame (107) and transmit an egress frame (108). The ports may connect to wires, optical cables, radios, or any other form capable of data reception and transmission. The ports may be virtual.

Switch (101) is provided with memory (105) and with forwarding database (106), stored in memory (105). Memory (105) may be embodied in various combinations of electronic memory, physical storage, and another other means of storing information and may be distributed among these.

When switch (105) receives a frame (ingress frame (107)) at a particular port (102), that port (102) is the ingress port of ingress frame (107) and the associated port ID (103) is the ingress port ID. When switch (105) sends a frame (egress frame (108)) out a particular port (102), that port (102) is the egress port of egress frame (108) and the associated port ID (103) is the egress port ID.

Switch (101) is provided with processing unit (CPU) (104), enabled to read data from forwarding database (106) as selected using database operations as such conventional relational database operations. CPU (104), may also be enabled to write data to forwarding database (106). CPU (104) may be distributed among various processing components and may include, for example, the ability to assign frames to queues in memory (105) based on frame properties, and the ability to schedule the processing of frames in queues.

CPU (104) is enabled to read ingress frame (107) along with the associated ingress port ID. CPU (104) is enabled to parse ingress frame (107) and determine the content of fields therein. Based on those fields of ingress frame (107), and possibly considering also associated ingress port ID, CPU (104) is enabled to refer to forwarding database (106) in determining egress frame (108), to select zero or more egress port IDs for each such egress frame (108) [as indicated in egress vector (110)], and to forward the determined egress frame (108) to the associated egress ports (102), subject to the normal networking proviso that the ingress port is disallowed as an egress port. CPU (104) may also be enabled to update forwarding database (106) according to information obtained from the receipt of ingress frame (107) and accompanying information

CPU (104) is also enabled to read programming code from memory (105) and execute it, enabling it to carry out instructions on the processing of frames.

### Forwarding Database

FIG. 1b further illustrates an embodiment of forwarding database (106). Forwarding database (106) records a number of frame conditions (109), identified as the illustrative set 109a-109f, respectively. Each frame condition (109) expresses the nature of some frames (107) and associated metadata (e.g., the ingress port) such that comparing this information to frame condition (109), which may include parsing and examining elements of this information, evaluates to a binary-valued result.

In an embodiment of forwarding database (106), each frame condition (109) is associated with a binary-valued egress vector (110) (Egress[ ]) typically of dimension k or k+1, where k is the number of ports in the switch. For example, illustrative frame conditions 109a-109f are associated with egress vectors 110a-110f, respectively, in FIG. 1b. Each egress vector (110) confers an indicator for each port ID (103). In the embodiment shown, the values of egress vector (110) are Egress[i], where i ranges from 0 through k. In that case, for i ranging from 0 through k−1, Egress[i] is set to 1 to indicate that the egress frame (104) is to be forwarded from the port (102) whose port ID (103) is equal to i. In the embodiment shown, egress vector (110) includes an additional binary-valued element, Egress[k], set to 1 to indicate that an egress frame (104) is to be forwarded to a local process within the switch. In embodiments not using Egress[k], the dimension of egress vector (110) may be reduced to k.

If frame condition (109) evaluates to TRUE for a frame, then the egress vector (110) associated with that frame condition (109) is selected. In an embodiment, no frame results in more than a single TRUE frame condition (109). In other embodiments, a procedure to select one of the TRUE egress vectors (110) is specified.

In embodiments of flow-zone switching, forwarding of unicast frames is processed without the use of forwarding database (106) and forwarding database (106) is referenced only for multicast frames.

### Host

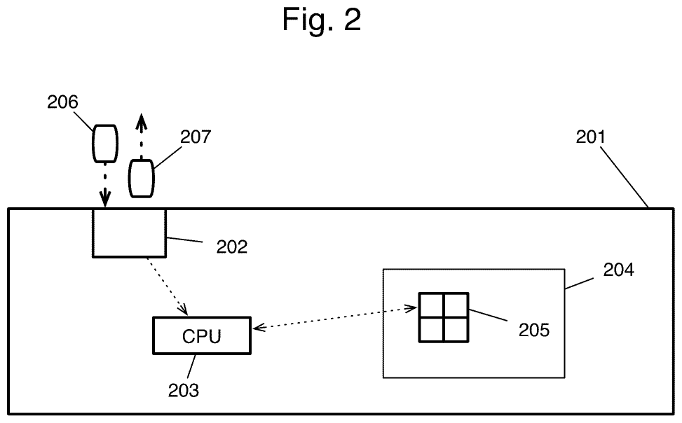

In this disclosure, host (201), an embodiment of which is illustrated in FIG. 2, is not considered a switch (101), although, it may share some of the attributes of a switch (101).

An embodiment of a host (201) used in illustrating this disclosure includes only a single host port (201). The principles of the disclosure are applicable to a physical host (201) with multiple host ports (201).

Host (201) is provided with host memory (204) and with host database (205), stored in memory (204). Memory (204) may be embodied in various combinations of electronic memory, physical storage, and another other means of storing information and may be distributed among these.

Host (201) is provided with host CPU (203), which is enabled to read data from host database (205) as selected using database operations as such conventional relational database operations. Host CPU (203) may be distributed among various processing components and may include, for example, the ability to assign frames to queues in host memory (204) based on frame properties, and the ability to schedule the processing of frames in queues.

Host CPU (203) is enabled to prepare and to forward a data unit, such as a Layer 2 data frame, and forward it for egress at host port (201) as host egress frame (207).

Host CPU (203) is enabled to read host ingress frame (205) following its receipt at host port (201). CPU (203) is enabled to parse host ingress frame (206) and determine the content of fields therein. Based on those fields of host ingress frame (206), host CPU (203) is enabled to refer to host database (205) in determining how to process host ingress frame (206). Host CPU (203) may also be enabled to update host database (205) according to information obtained from the receipt of host ingress frame (206) and accompanying information.

### Host-Driven Collective Multicast in a Tree

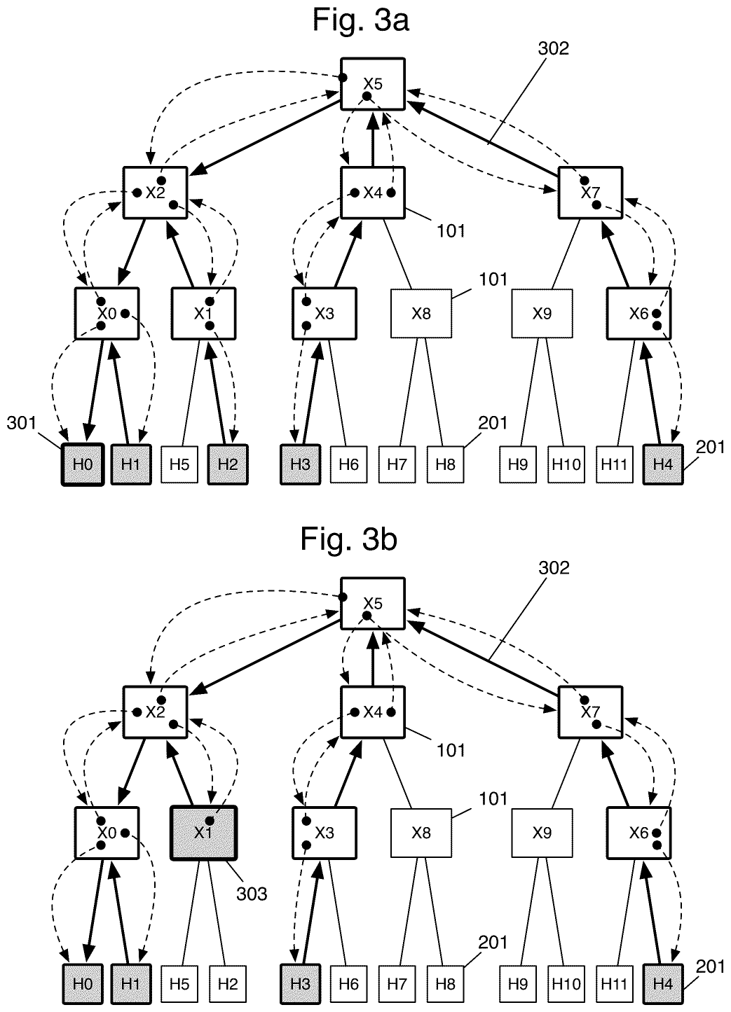

FIG. 3a illustrates an embodiment of collective multicast in a tree. The example of FIG. 3a, includes ten instances of switch (101) labeled X1-X9, and twelve instance of host (201) labeled H1-H11. The quantity of such elements is immaterial to the disclosure and for illustration only.

As illustrated in FIG. 3a, the connectivity in this example is a singly-connected tree. As a consequence, only a single route exists from any host (201) to another host (201).

To illustrate the process, consider an example that begins with hosts seeking to join a communication with originating host (301). For example, FIG. 3a indicates hosts H1, H2, H3 and H4 seeking to join a communication with host H0, the originating host (301). Here H0 may have issued a broadcast advertisement notifying the availability of a data it may issue using a multicast address within a collective address set, wherein the announcement includes a unicast address of H0. This does not rely on the process by which host (201) learns about the collective address set and the unicast address of the originating host (301).

In the first stage of the process, hosts H1, H2, H3 and H4 each issue a collective assignment frame (302) specifying the collective address set. Each collective assignment frame (302) is delivered to a delivery address, which is set to an address of H0. In some embodiments, the collective assignment frame (302) is issued as a unicast frame whose destination address is that delivery address, with a proviso that switches along the route will examine the frame en route. In other embodiments, it is addressed otherwise. For example, the destination address of collective assignment frame (302) may be the Nearest Customer Bridge (NCB) address or other scope-limited address of IEEE Std 802.1Q, with a proviso that switches along the route will forward the collective assignment frame (302) only via the port toward a delivery address stored in the data payload. In such a case, the delivery address (set to an address of H0) may be carried in the data payload.

The proviso notifying the switch to examine the collective assignment frame (302) and forward it toward the delivery address is in some embodiments triggered by, for example, a distinctive EtherType, which is a standardized and well-known element of a frame providing protocol identification, and possibly a subsequent subtype.

Consequently, the collective assignment frames (302) from H1, H2, H3, and H4 are forwarded in the network toward the delivery address, resulting in delivery to H0. This is illustrated by the heavy arrows on some links in FIG. 3a. In some cases, multiple collective assignment frames (302) flow on the same link, as routes to H0 converge.

This completes the messaging required for configuration of the host-driven collective multicast. The only configuration messages are these unidirectional collective assignment frames (302) from each responding host to the originating host (301).

The configuration of the network occurs in the switches as they receive and pass along the collective assignment frames (302). This is explained as follows.

Each switch, upon receiving a collective assignment frame (302), creates an egress vector (110) with Egress[i] and Egress[j] set to 1 for the two port ID (103) values i and j, where (a) i identifies the ingress port of the collective assignment frame (302); and (b) j identifies the egress port of the collective assignment frame (302), selected as the port toward the delivery address. The switch enters that egress vector (110) into forwarding database (106) along with an associated frame condition (109); however, if the associated frame condition (109) already exists in an egress vector (110) in forwarding database (106), the switch updates that existing egress vector (110), setting Egress[k] to 1 for the port ID (103) value k, where k is the ingress port of the collective assignment frame (302). In some embodiments, the frame condition (109) is a match of the frame destination address with any address within the collective address set (as carried in the collective assignment frame (302)).

FIG. 3a illustrates (with broken curves) these egress vectors (110). For example, when switch X6 receives the collective assignment frame (302) from H4, it establishes an entry in forwarding database (106) that, upon a match of the frame destination address to any address within the collective address set (possibly limited to frames received at ports toward X7 and H4), instructs the switch to forward the frame via the port (102) toward X7 and the port (102) toward H4, subject to the previously-noted proviso that the ingress port is disallowed as an egress port. The solid dots at the ends of the broken curves indicate the location of the forwarding database (106) containing the instruction; the arrows at the ends of the broken curves indicate the destinations to which that forwarding database (106) forwards the frame. Switches X0 and X2 of FIG. 3a illustrate the scenario in which an additional collective assignment frame (302) results in an egress vector (110) indicating forwarding to more than two egress ports.

Once the collective assignment frames (302) have been received at originating host H0, H0 may send a frame to any multicast destination address within the collective address set and it will be delivered to all of the hosts that requested receipt. For example, when switch X0 receives the frame, a frame condition (109) in forwarding database (106) evaluates to TRUE and the associated egress vector (110) indicates forwarding to the ports toward H0, H1, and X2. Return via the ingress port to H0 is disallowed, so the frame is forwarded toward H1 and X2. At H1, it is received as requested. At X2, is forwarded on to X1, en route to H2, and to X5, en route to H3 and H4.

It is clear from this example that this approach configures the network to deliver multicast frames from the source H0 over the minimal spanning tree associated with the subset of hosts, without any frames to elements not on that minimal spanning tree.

Some embodiments take advantage of another property of the approach: that, without further effort, it configures the network for collective multicast among all the hosts in the spanning tree group; in the example, among all hosts H0-H4. As shown by the broken curves in FIG. 3a, the configuration of the forwarding databases (106) in the switches treats all of these hosts identically. Any of H0-H4 can transmit using an address within the collective address set; the network will deliver the frame to the remaining hosts along the same minimal spanning tree. Thus, collective multicast among the host group is enabled.

The originating host H0 differs from the other members of the collective in that it has received a collective assignment frame (302) from the others and consequently can know the other members, if their identity was provided in the response. The source can determine to not transmit if no collective assignment frames (302) are received, indicating that no recipients are available. Each other host in the collective may determine that at least one recipient is available; namely, the originating host.

In some embodiments, the originating host provides a multicast message to a collective multicast address following receipt of the collective assignment frames (302). Such a message can confirm receipt of the collective assignment frame (302) and, in some embodiments, provide additional information, such as the size of the group or a list (ordered or unordered) of the group identities.

In some embodiments, the originating host provides a unicast message to members of the collective following receipt of the collective assignment frames (302). Such a message can confirm receipt of the collective assignment frame (302) and, in some embodiments, provide additional information, such as the size of the group or a list of the group identities, or an ordering of the member within the group.

In some embodiments, switches are configured to not forward collective multicast frames, even those matching a frame condition (109), if the ingress port of the frame was not one of those associated with that frame condition (109) in the associated egress vector (110). This restricts the ability of network elements at other ports to inject frames addressed to the collective address set. In other embodiments, supporting an “open send” model, forwarding is not so restricted.

### Root-Driven Collective Multicast in a Tree

As is apparent from the description of “Host-driven collective multicast in a tree” above, the originating host can be replaced by a switch without altering the functionality. FIG. 3b provides an example. Here, switch X1 serves as the originating switch (303) rather than originating host (301) in the description, even though its attached hosts are not members of the collective. Switch X1 then forwards frames for the collective while not participating in the collective as a source or destination of collective frames.

### Root-Assigned Collective Multicast in a Tree

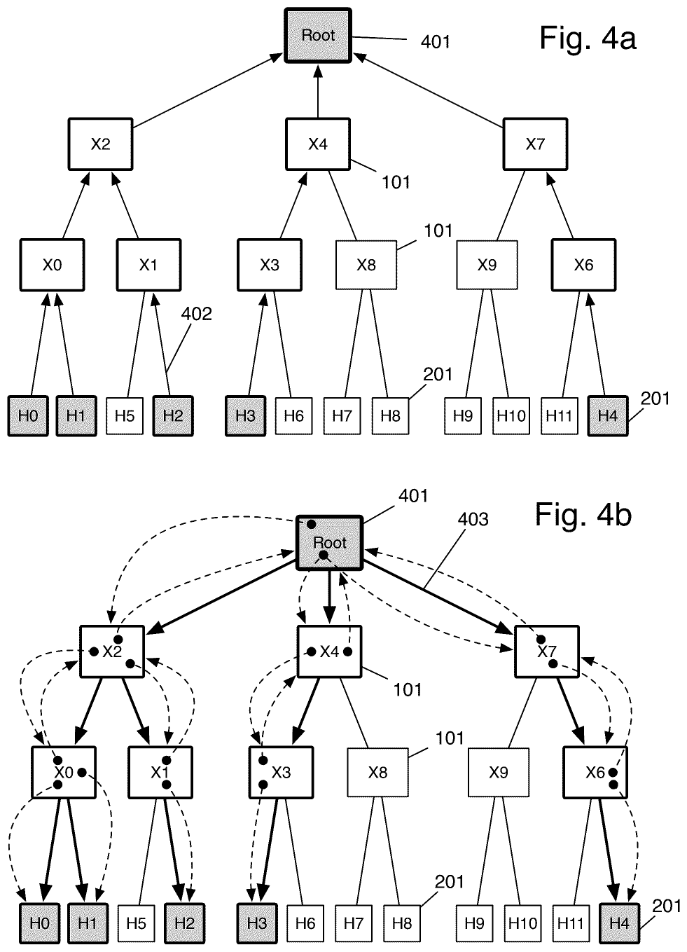

In some cases, a set of hosts need to jointly and independently initiate a collective, and a conflict may arise if two different groups initiate a collective with identical addresses. Some embodiments address this problem with root-assigned collective multicast. An example is illustrated in FIG. 4a and FIG. 4b.

FIG. 4a illustrates a tree network in which one of the switches is a root (401). In this example, the root (401) is a root switch. The procedure operates virtually identically when the root is a host (201).

In some cases, the set of hosts needs to form a group with multiple independent communicators, each representing an independent collective communication among the same group of hosts. The approach provides for single process to configure a set of collectives, each identified by a multicast collective address within a collective address set, within a common collective group of hosts.

In the request stage of the procedure, each host (201) requesting membership in a collective sends a collective request frame (402) to the root. FIG. 4a illustrates not the detailed content of collective request frame (402) but, as indicated by the arrowed solid lines, the paths takes by collective request frame (402) from host (201) to root (401). Each such collective request frame (402) includes the same collective request identifier, so that the root can distinguish the request for this collective with respect to requests for other collectives. This stage requires that each host (201) requesting membership have access to the same collective request identifier and the same root address. In some embodiments, collective request frames (402) include the quantity of members making the request with the common collective request identifier. In some embodiments, collective request frames (402) specify the requested size of the collective address set. FIG. 4a illustrates, with arrowed solid lines, the route of such collective request frames (402) from five such requesting hosts (H0, H1, H2, H4, and H4).

FIG. 4b illustrates an embodiment of the assignment stage in root-assigned collective multicast in a tree. In this stage, the root has received the host collective request frames (402). In some embodiments, the root (401) may wait until all such frames have been received, based on the known quantity of requests, if provided in the membership request.

The root (401) assigns one or more multicast addresses for assignment to the group as a collective address set, typically selecting a set large enough to meet the quantity of collective addresses requested. The collective addresses so assigned may be drawn from a larger set of addresses assigned to the root (401) for sub-assignment to meet such collective address requests.

The root (401) creates a collective assignment frame known as an assign frame (403) to convey to each host (201) in response to its membership request, or, in some embodiments, only to those meeting a condition for membership. FIG. 4b illustrates not the detailed content of assign frame (403) but, as indicated by the arrowed solid lines, the paths taken by assign frames (403) from the root (401) to hosts (201). Each collective assignment frame (403) contains a delivery address set to the unicast address of a host (201) having made an earlier request; this delivery address may be set to the source address of the host collective request frame (402). The data payload of the assign frame (403) also contains an expression of the collective address set assigned. In various embodiments, this expression takes various forms. For example, it may be a single collective address and a quantity of addresses, with a formula (included or implied) indicating how the addresses are calculated from the single collective address; for example, the addresses may be the single address and all consecutive addresses about it numerically, up to the specified quantity. As another example, some embodiments include an identifier of a range of addresses in which bits in some bit positions of the address are explicitly stated and others are indicated as “wild-card” values, such that addresses with any value in the wild-card bit will fall within the set of the collective address sub-assignment.

In some embodiments, the assign frame (403) is issued as a unicast frame addressed to the delivery address, with a proviso that switches along the route will examine the frame en route. In other embodiments, the assign frame (403) is addressed otherwise; for example, the destination address may be the Nearest Customer Bridge (NCB) address or other scope-limited address of IEEE Std 802.1Q, with a proviso that switches along the route will forward the frame only via the port toward the requesting host, whose address is included in the assign frame (403). The proviso notifying the switch to examine the frame and forward it toward the requesting host can be triggered by, for example, a distinctive EtherType, as specified in standardized Layer 2 frame formats, and sometimes a subsequent subtype. In this case, the delivery address is in some embodiments carried in the data payload of assign frame (403).

Following the assignment stage, the messaging required for configuration of the collective multicast is complete. The configuration of the network occurs in the switches as they receive and pass along the assign frames (403). This is explained as follows.

Each switch, upon receiving an assign frame (403), creates an egress vector (110) with Egress[i] and Egress[j] set to 1 for the two port ID (103) values i and j, where (a) i identifies the ingress port of the assign frame (403); and (b) j identifies the egress port of the assign frame (403). The switch enters that egress vector (110) into forwarding database (106) along with an associated frame condition (109); however, if the associated frame condition (109) already exists in an egress vector (110) in forwarding database (106), the switch updates that existing egress vector (110), setting Egress[k] to 1 for the port ID (103) value k, where k identifies the egress port of the assign frame (403). In some embodiments, the frame condition (109) is a match of the frame destination address with any address within the collective address set assignment.

FIG. 4b illustrates (with broken curves) these egress vectors (110). For example, when switch X6 receives the assign frame (403) from X7, it establishes an entry in forwarding database (106) that, upon a match of a frame destination address with any address within the collective address (possibly limited to those received at ports toward X7 and H4), instructs the switch to forward the frame via the port (102) toward X7 and the port (102) toward H4, subject to the previously-noted proviso that the ingress port is disallowed as an egress port. The solid dots at the ends of the broken curves indicate the location of the forwarding database (106) containing the instruction; the arrows at the ends of the broken curves indicate the destinations to which that forwarding database (106) forwards the frame.

Each host receiving a collective assignment frame adopts the assigned collective address set and uses it to address collective multicast communications.

It is clear from this example that this approach configures the network to deliver multicast frames from any of the group hosts over the minimal spanning tree associated with the set of requesting hosts, without any frames to elements not on that minimal spanning tree.

In some embodiments, the assign frame (403) provides additional information, such as the size of the group, a list (ordered or unordered) of the group identities, and an ordering of the member within the group.

In some embodiments, switches are configured to not forward collective multicast frames, even those matching a frame condition (109), if the ingress port of the frame was not one of those associated with that frame condition (109) in the associated egress vector (110). This restricts the ability of network elements at other ports to inject frames addressed to the collective address set. In other embodiments, supporting an “open send” model, forwarding is not so restricted.

### Clos Fat-Tree

Many networks are configured not as a singly-connected tree but as a multiply-connected network, such as a Clos fat-tree. Note here that the term fat-tree is in wide use and is used here, with the caution that a Clos fat-tree is not singly-connected and is therefore not a tree.

Embodiments of the Clos fat-trees described herein take the form of a k-ary Clos fat-tree, where k is an even integer and the Clos fat-tree has three levels. (Throughout this disclosure, the variable k is used exclusively to indicate the fat-tree dimension.) Alternative embodiments use more general fat-trees.

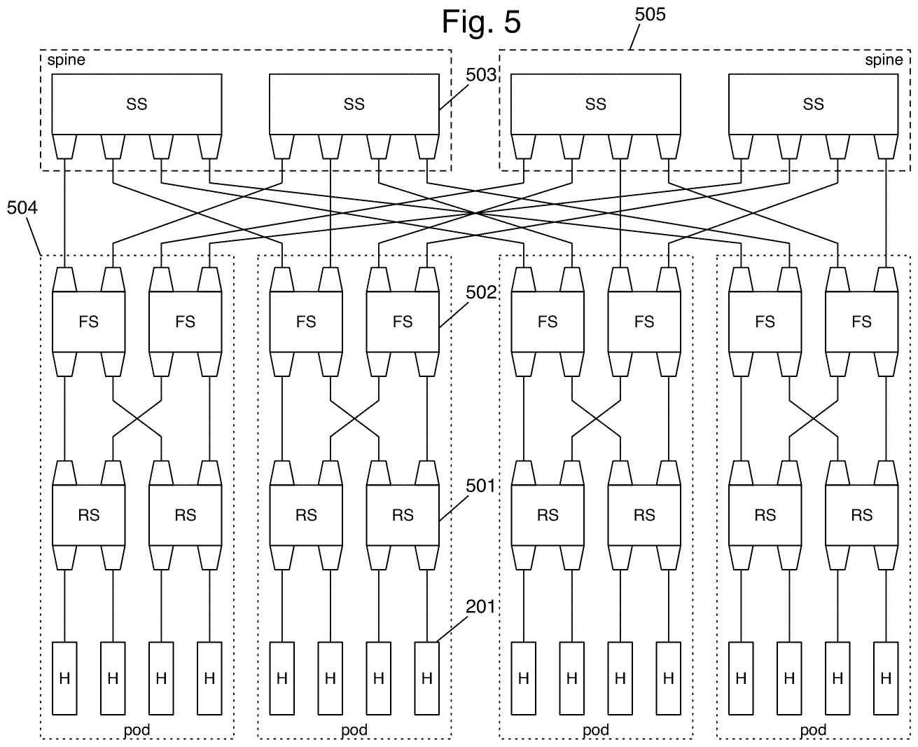

The k-ary fat-tree is illustrated in the example, with k=4, of FIG. 5. The nature of the k-ary fat-tree is as follows:

The network supports k³/3 instances of host (201).

Network switches (101), each with k ports, are provided. These are organized in three levels. At the lowest level, k²/2 instances of rack switch (501) are provided. At the middle level, k²/2 instances of fabric switch (502) are provided. At the highest level, k²/4 instances of spine switch (503) are provided.

Each rack switch (501) connects to k/2 hosts and k/2 fabric switch (502). Each fabric switch (502) connects to k/2 rack switches (501) and k/2 spine switches (503).

The network is organized into k instances of pod (504). Each pod (504) includes k/2 fabric switches (502) and k/2 rack switches (501). Each fabric switch (502) in the pod is connected to each rack switch (501) in the pod.

The network is organized into k/2 spines (505). Each spine (505) includes k/2 spine switches (503). Each spine switch (503) is connected to one fabric switch (502) in each pod (504).

### Clos Fat-Tree Addressing and Numerology

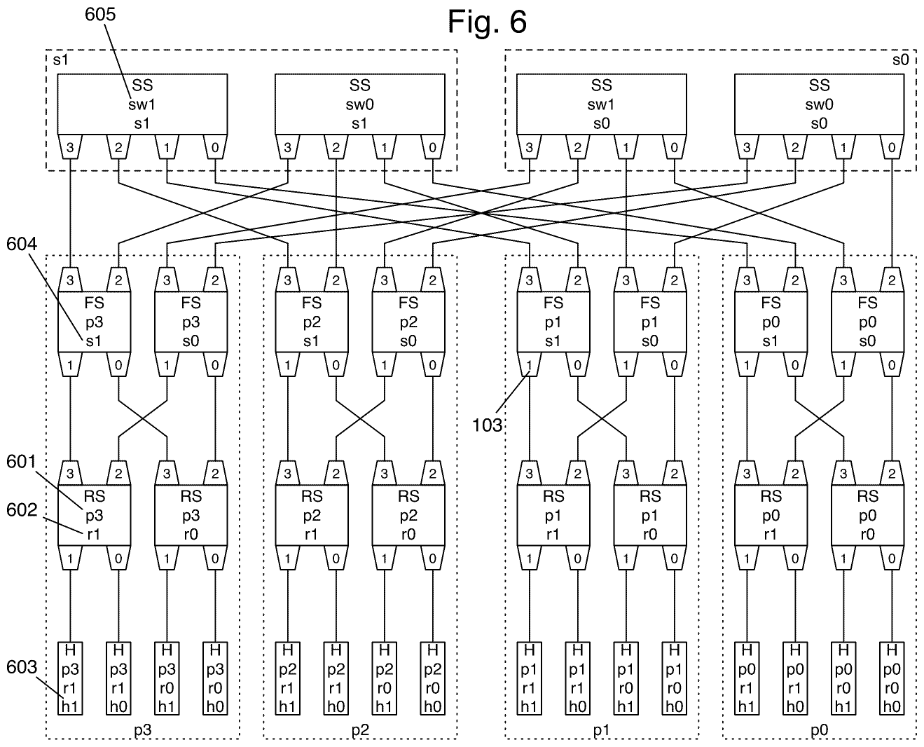

Embodiments operate the k-ary Clos fat-tree using enumeration of elements as specified generally in accordance with my U.S. Pat. No. 11,418,460 B2 (“Flow-zone switching”), as illustrated in FIG. 6 and described herein.

Each switch knows the identify each of its ports by an internal port ID (103). As shown, each k-port switch has port ID values ranging from 0 through k−1. The connectivity among the ports is described in U.S. Pat. No. 11,418,460 B2.

The alignment of the ports and switch identifiers requires configuration. Automated configuration methods are described elsewhere; e.g., in U.S. Pat. No. 11,418,460 B2.

The pods (504) are numbered from 0 through k−1. The rack switches (501) in a pod (504) are identified with three fields. The first holds a constant element type identifier (symbolized by “RS”) indicating that the switch is a rack switch (501). The second holds a pod identifier (601) (pod ID, symbolized in FIG. 6 by the number following “p”) identifying the pod in which the rack is contained. The third holds a rack identifier (602) (rack ID, symbolized in FIG. 6 by the number following “r”) identifying the rack among those in its pod. The rack identifier is numbered from 0 through k/2-1. As a result of this enumeration, each rack is uniquely identified among the racks by its pod ID (601) and rack ID (602).

Each host is given a unique identifier comprising four fields: (a) a constant element type identifier (symbolized by “H”) indicating that the element is a host; (b) a pod ID (601) identical to that of the rack switch of attachment; (c) a rack ID (602) identical to that of the rack switch of attachment; and (d) a host identifier (603) (host ID, symbolized in FIG. 6 by the number following “h”) identifying the host among those attached to its rack. The host identifier is numbered from 0 through k/2−1.

Each fabric switch is given a unique identifier comprising three fields: (a) a constant element type identifier (symbolized by “FS”) indicating that the element is a fabric switch; (b) a pod ID (601) identifying the pod of the fabric switch and identical to the pod ID (601) of its attached rack switches; and (c) a spine identifier (604) (spine ID, symbolized in FIG. 6 by the number following “s”) indicating the single spine to which it is attached. The spine identifier (604) is numbered from 0 through k/2−1.

Each spine switch is given a unique identifier comprising three fields: (a) a constant element type identifier (symbolized by “SS”) indicating that the element is a spine switch; (b) a spine identifier indicating the spine of the spine switch and identical to that of its attached fabric switches; and (c) a spine switch identifier (605) (spine switch ID, symbolized in FIG. 6 by the number following “sw”) indicating the identifier of the spine switch among the switches of the spine. The spine switch identifier is numbered from 0 through k−1.

Thus, each switch and host in the network is given a unique identifier.

### Clos Fat-Tree Port Connectivity

Disclosures described herein are based on specific connectivity among the network elements and the identity of the switch ports, as illustrated in FIG. 6.

For each rack switch, each port with port ID (103) from 0 through k/2−1 is attached to a host, with the host ID h equal to the port ID of the rack switch port to which it is attached. For each rack switch port ID i from k/2 through k−1, the rack switch is attached to a fabric switch, with the spine ID's of the fabric switch related to i by the relation s=i−k/2.

For each fabric switch, each port with port ID from 0 through k/2−1 is attached to a rack switch, with the rack ID equal to the port ID of the fabric switch port to which it is attached. For each fabric switch port ID i from k/2 through k−1, the fabric switch is attached to a spine switch, with the spine switch ID sw of the spine switch related to i by the relation sw=i−k/2.

For each spine switch, each port is attached to a fabric switch whose pod ID is equal to the port ID of the spine switch port to which it is attached.

### Clos Fat-Tree Element Address Blocks

In embodiments, each switch and host is assigned local and multicast addresses for its use in the network. In embodiments, these take the form of Address Blocks, as described in, for example, International Patent Publication WO 2022/076942 A1. Here an Address Block (AB) is a contiguous set of local and multicast addresses and is uniquely assigned to a network element.

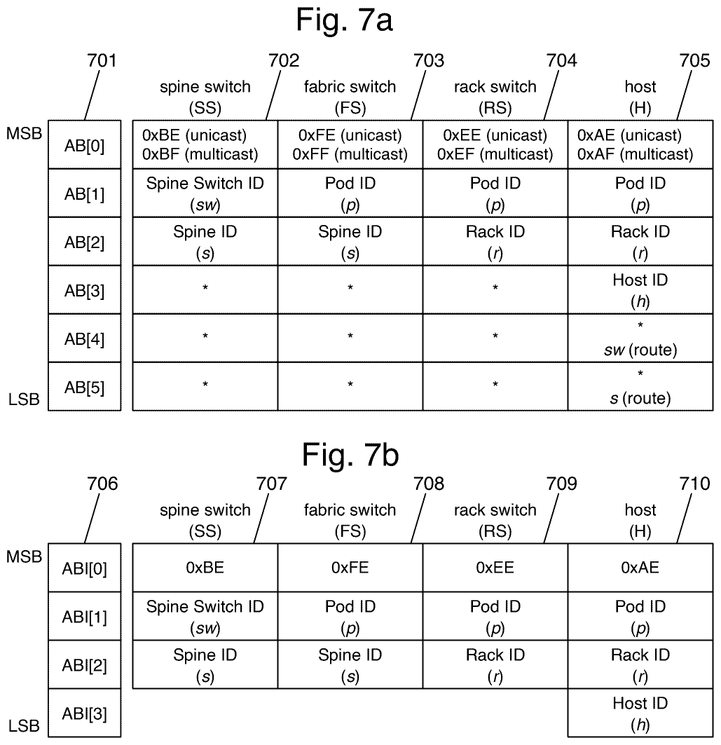

FIG. 7a illustrates ABs used in an embodiment. Each address is six octets, per standard Layer 2 address format. Each column of the table represents an AB (701), including the spine switch AB (702), the fabric switch AB (703), the rack switch AB (704), and the host AB (705).

Each row of the table represents an octet AB[i] of the address block, where AB[0] is the most significant byte and AB[5] the least. In FIG. 7a, an asterisk (*) is a wild-card indicator, indicating that all possible values are included in the Address Block.

As shown in FIG. 7a, a spine switch with Spine Switch ID sw and Spine ID s is assigned a block of addresses of which AB[1]=sw and AB[2]=s. AB[0] takes a value that uniquely identifies the address as that of a spine switch and also identifies whether the address is a unicast or multicast address. In the case of the spine switch, an embodiment sets AB[0]=0xBE for a unicast address and AB[0]=0xBF for a multicast address. As shown in FIG. 7a, AB[3], AB[4], and AB[5] are wild-card values, indicating that an address with any value in the octet is assigned to the spine switch.

As shown in FIG. 7a, a fabric switch with Pod ID p and Spine ID s is assigned a block of addresses of which AB[1]=p and AB[2]=s. In the case of the fabric switch, an embodiment sets AB[0]-0xFE for a unicast address and AB[0]=0xFE for a multicast address. As shown in FIG. 7a, AB[3], AB[4], and AB[5] are wild-card values.

As shown in FIG. 7a, a rack switch with Pod ID p and Rack ID r is assigned a block of addresses of which AB[1]=p and AB[2]=r. In the case of the rack switch, an embodiment sets AB[0]=0xEE for a unicast address and AB[0]=0xEE for a multicast address. As shown in FIG. 7a, AB[3], AB[4], and AB[5] are wild-card values.

As shown in FIG. 7a, a host with Pod ID p, Rack ID r, and Host ID h is assigned a block of addresses of which AB[1]=p, AB[2]=r, and AB[3]=h. In the case of the host, an embodiment sets AB[0]-0xAE for a unicast address and AB[0]=0xAE for a multicast address. As shown in FIG. 7a, AB[4] and AB[5] are wild-card values, and an address with any value in the octet is assigned to the host.

In an embodiment, the host may use the values of AB[4] and AB[5] to indicate a forwarding route. For example, if forwarding to a specific host destination address requires routing up to a fabric switch, the rack switch selects the fabric switch with Spine ID s equal to AB[5]. Likewise, if forwarding to a specific host destination address requires routing up to a spine switch, the fabric switch selects the spine switch with Spine Switch ID sw equal to AB[4].

FIG. 7b specifies values of an Address Block Identifier (ABI) assigned to each element. Each such ABI (706) identifies the associated AB and its addresses. In the embodiment of FIG. 7b, the SS ABI (707) has ABI[0]=0xBE, ABI[1]=sw, and ABI[2]=s; the FS ABI (708) has ABI[0]=0xFE, ABI[1]=p, and ABI[2]=s; the RS ABI (709) has ABI[0]=0xEE, ABI[1]=p, and ABI[2]=r; and the host ABI (710) has ABI[0]=0xAE, ABI[1]=p, ABI[2]=r, and ABI[3]=h.

### Clos Fat-Tree Identifier Assignment

In embodiments, the set of switches is connected, using the port-to-port connectivity illustrated, prior to the assignment of identifiers to the switches and hosts. At this time, the switches may all be identical; none of them is presumed to be aware of its fat-tree element type identifier nor its topology identifiers. Subsequently, an automated procedure may assigns the correct element identifiers to each network element and store those within the network element.

In some embodiments, the form of the process is related to the Block Address Registration and Claiming (BARC) procedure of International Patent Publication WO 2022/076942 A1.

### Clos Fat-Tree Switch Operation

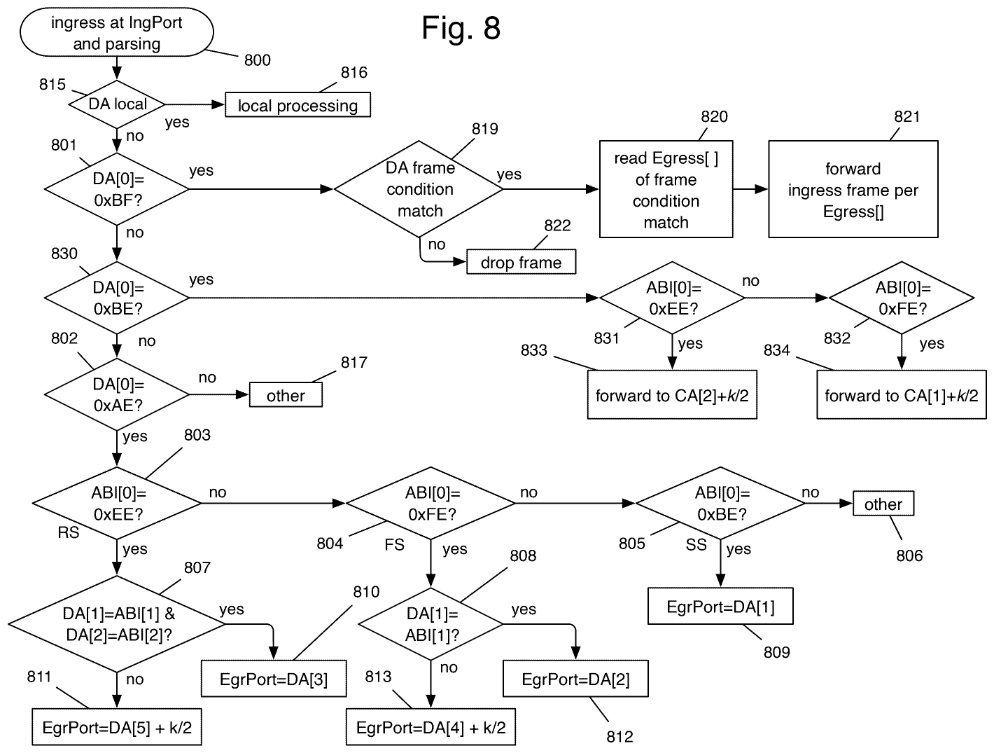

In an embodiment, a switch (whether rack switch, fabric switch, or spine switch) processes ingress frames as described in FIG. 8.

In Step 800, the switch with Address Block Indicator ABI receives an ingress frame at ingress port IgrPort and parses it to determine within it a Destination Address DA, which comprises six octets DA[i], where i ranges from 0 (most significant) to 5 (least significant).

In Step 815, the DA is examined to determine if the destination is local to the switch. It is determined to be local if the DA is in the AB specified by ABI; namely, if DA[0]=ABI[0], DA[1]=ABI[1], and DA[2]=ABI[2]. Other values of DA also lead to a determination of locality. In an embodiment, the destination is also determined to be local if DA=01-80-C2-00-00-00, the “nearest customer bridge” address identifier specified in IEEE Std 802.1Q. If the destination is determined to be local to the switch, then local processing proceeds in Step 816. Otherwise, Step 801 ensues.

In Step 801, the DA is examined to determine if the frame is a collective frame. In some embodiments, collective frames are identified by a DA[0] value of 0xBF; in other embodiments, additional aspects of the frame (such as other aspects of the DA) are considered in qualifying the frame as a collective frame. In the example of FIG. 8, Step 801 checks whether DA[0]=0xBF. If so, then Step 819 ensues, leading to collective forwarding, as described below. If not, then Step 830 ensues.

In Step 830, the DA is examined to determine if the frame is unicast to an SS, by comparing DA[0] to the SS ABI[0] of FIG. 7b; namely 0xBE. If so, then Step 831 ensues, leading to forwarding of the frame toward the SS. If not, then Step 802 ensues.

In an RS (501), where ABI[0]=0xEE, Step 831 leads to Step 833, in which RS (501) forwards the frame to port CA[2]+k/2. In an FS (502), where ABI[0]=0xFE, Step 832 leads to Step 834, in which FS (502) forwards the frame to port CA[1]+k/2.

In Step 802, the DA is examined to determine if the destination is a host, by comparing DA[0] to the host ABI[0] of FIG. 7b; namely 0xAE. If so, then Step 803 ensues, leading to forwarding of the frame toward the destination host. If not, then Step 817 ensues. The actions of Step 817 are not specified herein.

In Steps 803-805, the switch examines its own ABI[0] to determine its switch type. In Step 803, if ABI[0]=0xEE (the rack switch ABI[0] of FIG. 7b), then the switch is a rack switch and Step 807 ensues. If not, then in Step 804, if ABI[0]=0xFE (the fabric switch ABI[0] of FIG. 7b), then the switch is a fabric switch and Step 808 ensues. If not, then in Step 805, if ABI[0]=0xBE (the spine switch ABI[0] of FIG. 7b), then the switch is a spine switch and Step 809 ensues. If not, then Step 806 takes action appropriate to a finding that the switch is misconfigured.

In Step 807, if DA[1]=ABI[1] and DA[2]=ABI[2], then the destination of the frame is a host attached directly to the rack switch. In this case, in Step 810, the rack switch identifies the egress port as the host ID value h, stored in DA[3], and forwards the egress frame out that egress port. Otherwise, Step 811 ensues.

In Step 811, the rack switch identifies the spine ID value s, stored in DA[5], as in FIG. 7a. It computes the egress port as DA[5]+k/2 (see “Clos fat-tree port connectivity” above), where k is the number of ports of the switch, and forwards the egress frame out that egress port.

In Step 808, if DA[1]=ABI[1], then the destination of the frame is a host within the pod of the fabric switch. In this case, in Step 812, the fabric switch identifies the egress port as the rack ID value r, stored in DA[2], and forwards the egress frame out that egress port. Otherwise, Step 813 ensues.

In Step 813, the fabric switch identifies the spine switch ID value sw, stored in DA[4], as in FIG. 7a. It computes the egress port as DA[4]+k/2 (see “Clos fat-tree port connectivity” above), where k is the number of ports of the switch, and forwards the egress frame out that egress port.

In Step 809, the spine switch identifies the pod ID value p, stored in DA[1], as in FIG. 7a. It computes the egress port as DA[1] and forwards the egress frame out that egress port.

### Collective Multicast Forwarding in a Clos Fat-Tree

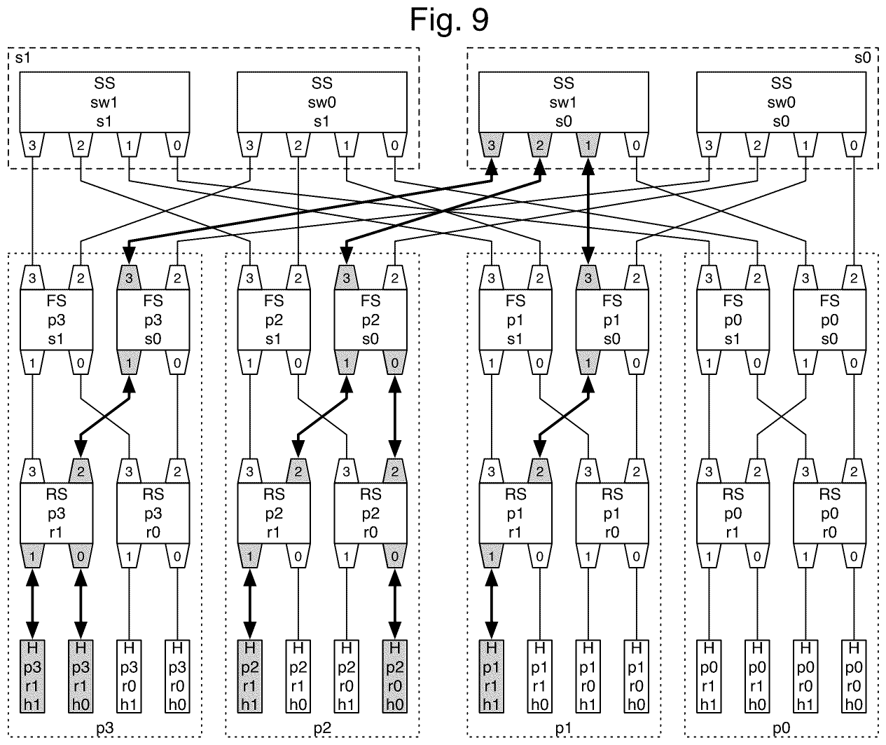

Collective multicast forwarding is illustrated in FIG. 9, in which five hosts (indicated by shading) are members of a collective group. The collective group members are connected along a collective tree containing a particular spine switch (204) that is associated with that collective group.

The network is configured so that a collective multicast frame, addressed to a collective address assigned to the collective group, from any member host is identified as a frame of the collective group and routed along the associated collective tree to the associated collective spine switch (204). Upon receipt, that collective spine switch (204) forwards the frame to each pod (other than the source pod) in which a collective group member exists. Subsequently (and during transit to the spine switch (204)), the collective multicast frame is replicated to ports leading along the collective tree to other collective group members.

For the collective illustrated in FIG. 9, consider, for example, a collective multicast frame from group member host p3/r1/h0 for which the group is associated with SS sw1/s0. After receipt, RS p3/r1 forwards the frame to member host p3/r1/h1 and to FS p3/s0, which forwards it to SS sw1/s0. SS sw1/S0 forwards the frame to both FS p1/s0 and FS p2/s0. FS p1/s0 forwards the frame to RS p1/r1, which forwards it to member host p1/r1/h1. FS p2/s0 forwards the frame to RS p2/10, which forwards it to member host p2/10/h0, and also to RS p2/r1, which forwards it to member host p2/r1/h1.

In order to provide for this routing, switches within the collective tree are configured to identify a frame as a collective frame, identify the collective tree, identify the ports of the collective tree, and forward the frame to each of those ports, except the ingress port.

As detailed above, in embodiments of flow-zone switching, forwarding of unicast frames is processed without the use of forwarding database (106). Here, in contrast, forwarding database (106) is used for collective multicast frames, each of whose destination address is presumed to lie in an SS multicast address block (702) and therefore begin with the byte 0xBF, as in FIG. 7a and Step 801 of FIG. 8.

Returning to FIG. 8, in Step 819, the switch compares the ingress frame to the egress vectors (110) stored in forwarding database (106) to determine whether a TRUE frame condition (109) exists. In some embodiments, the frame condition is a match of the DA to a DA within a collective address set stored in the frame condition record. In some embodiments, the switch furthermore limits the match to frames received via ingress specified ports, eliminating the ability of network elements at other ports to inject frames using the collective multicast address. For example, in such an embodiment, RS p3/r1 would be configured to not forward frames to the collective multicast address received via port 3.

In Step 819, if a TRUE frame condition (109) is found, Step 820 ensues. Otherwise, the frame is dropped (discarded) in Step 822.

In Step 820, the switch reads the egress vector (110) (Egress[ ]) associated with the TRUE-valued frame condition (109). In Step 821, the switch forwards the frame to each port whose port ID (103) is indicated among egress vector (110), with the exception of the ingress port. For example, for a collective frame from collective member host p3/r1/h0 for which the collective is associated with SS sw1/s0, as in FIG. 8, RS p3/r1 finds that egress vector (110) indicates port ID values 0, 1, and 2 and forwards the frame to ports 1 and 2, excluding the ingress port 0.

When the collective group involves hosts in multiple pods, the collective tree is a minimal spanning tree. Otherwise, it includes extra links. However, these extra links do not impede the delivery of frames to the members. For example, in FIG. 9, if only the leftmost hosts (p3/r1/h1 and p3/r1/h0) joined a collective, the collective tree would join those hosts directly via rack switch p3/r1 and frames would be routed directed through that rack switch. However, a copy would also be sent to the CA spine switch. Likewise, a collective with the two pod 2 hosts p2/r1/h1 and p2/r0/h0 would route via a fabric switch such as p2/s0 but would also forward a copy to the CA spine switch. In some embodiments, a message from the spine switch directs a fabric switch or rack switch not to forward up CA frames when they are unneeded; for example, by eliminating the upward egress ports from the CA egress vector.

### Host-Driven Clos Fat-Tree Collective Multicast

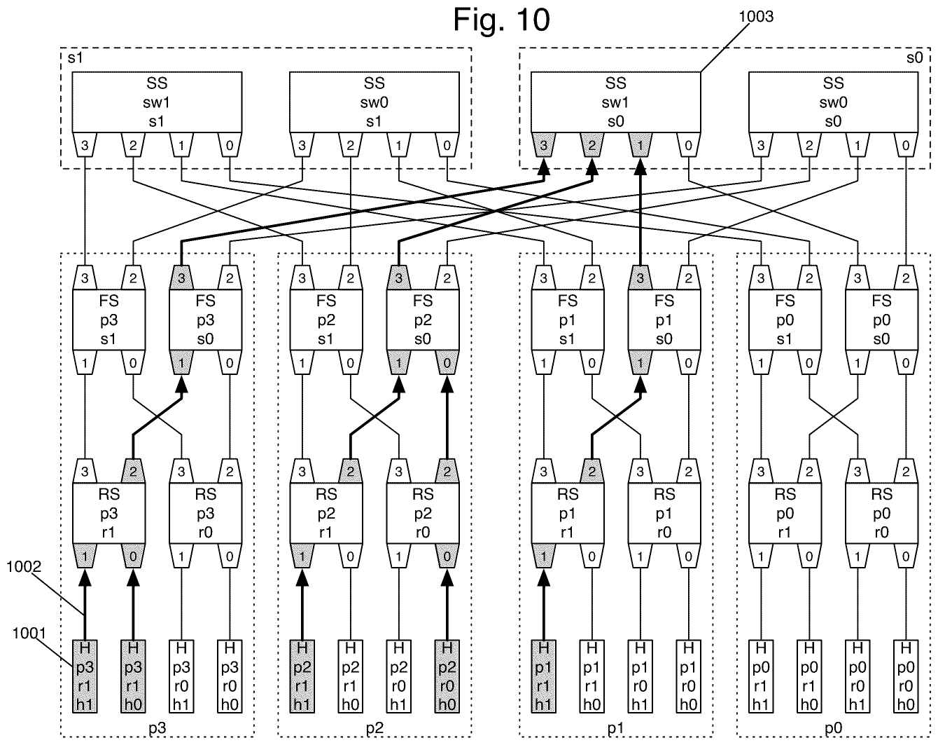

The concept behind host-driven Clos fat-tree collective multicast is illustrated in the example of FIG. 10.

At the start of the process, a group of hosts interested in joining a collective each holds a collective address (CA), unique to the group and to a collective among them. The CA is a six-octet multicast address (with octets CA[i], with CA[0] the most significant) within the address block of a spine switch, known as the CA spine switch of the respective CA. As shown in FIG. 7a, CA[0]=0xBE, CA[1]=sw, and CA[2]=s, where sw and s together uniquely identify a spine switch. CA[3], CA[4], and CA[5] are set to uniquely identify the collective by distinguishing it from other collectives associated with the same spine switch.

In some embodiments, a distinctive indication is made among the fields CA[3], CA[4], and CA[5] to distinguish a CA with respect to other non-CA multicast addresses belonging to the address block of the spine switch.

In some embodiments, the hosts in the group hold a plurality of CAs, known as a collective address set (CA set). While all the CAs in the set are unique to the group, various CAs within the group may identify various collective communications (i.e., communicators) of that group, or various processes within the hosts. All CAs within a CA set are associated with the same spine switch.

Various embodiments use various means to assign a CA to a group and provide the CA to hosts that are prospective members of the collective. In some embodiments, a broadcast or multicast message is sent to prospective hosts, providing a CA or CA set and describing its nature sufficiently for prospective members to initiate membership. In other embodiments, hosts determine to join a CA individually using an algorithm providing a common CA. The means by which the CA becomes known to hosts is immaterial to the disclosure.

To illustrate the process, consider an example that begins with hosts (such as those shaded in FIG. 10) seeking to join a collective. Each such collective host (1001) issues a join frame (1002), specifying its interest in joining the collective based at CA spine switch (1003). The join frame (1002) may be issued with a destination address set to the Nearest Customer Bridge (NCB) address or other scope-limited address of IEEE Std 802.1Q, with a proviso that switches (RS (501) and FS (502)) along the route will forward join frame (1002) only via an egress port that is the port toward the CA spine switch (1003), an address to which is identified within the join frame (1002) as a delivery address. The delivery address may be implicitly determined from the CA set because the CA set is associated with a particular spine switch and belongs to the set of multicast addresses associated with that spine switch. The proviso notifying RS (501) and FS (502) to examine join frame (1002) and forward it toward CA spine switch (1003) can be triggered by, for example, a distinctive EtherType and subtype.

The join frame (1002) content includes the CA set and the (in some cases, implicit) delivery address. In some embodiments, join frame (1002) content includes the quantity of members joining the collective.

In an embodiment, host (201) initiates the join request, issuing join frame (1002) using the NCB address as the destination address. Consequently, join frame (1002) is forwarded in the network via RS (501) and FS (502) to the CA spine switch (1003). This is illustrated by the heavy arrowed segments on some links in FIG. 9. In some cases, multiple join frames (1002) flow on the same link, as routes to the CA spine switch (1003) converge. In some embodiments, such repeated join frames are suppressed.

This completes the messaging required for configuration of the collective multicast. The only configuration messages are these unidirectional join frames (1002) from each collective host (1001) to the CA spine switch (1003). The configuration of the network occurs in the switches as they receive and pass along the join frames (1002). This is explained as follows.

Each switch, upon receiving a join frame (1002), creates an egress vector (110) with Egress[i] and Egress[j] set to 1 for the two port ID (103) values i and j, where (a) i is the ingress port of join frame (1002); and (b) j is the egress port of join frame (1002). For SS (503), the egress port is null because the join frame (1002) has reached its destination. The switch enters that egress vector (110) into forwarding database (106) along with an associated frame condition (109); however, if the associated frame condition (109) already exists in an egress vector (110) in forwarding database (106), the switch updates that existing egress vector (110), setting Egress[k] to 1 for the port ID (103) value k, where k identifies the ingress port of the join frame (1002).

In some embodiments, the CA spine switch provides a multicast response message to one or more CAs of the CA set following receipt of a join frame (1002). Such a response message can confirm receipt of the request and, in some embodiments, provide additional information, such as the size of the group or a list (ordered or unordered) of the group identities.

In some embodiments, the CA spine switch provides a unicast message to members of the collective following receipt of a join frame. Such a message can confirm receipt of the request and, in some embodiments, provide additional information, such as the size of the group or a list of the group identities, or an ordering of the member within the collective.

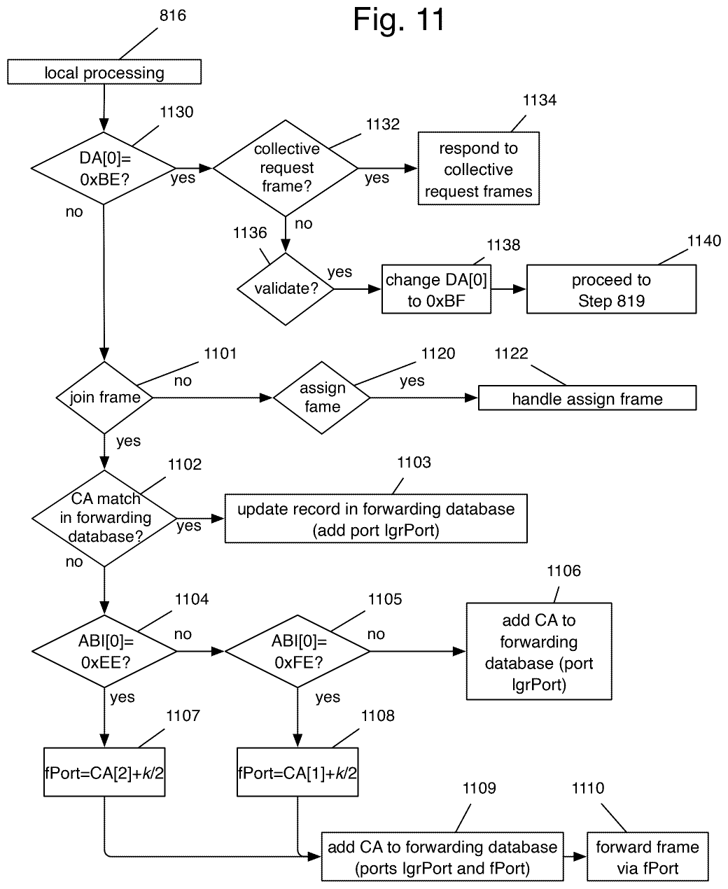

Further details of the host-driven Clos fat-tree collective multicast configuration are illustrated in FIG. 11. As in FIG. 8, the procedure of FIG. 11 can be implemented identically in each switch.

Step 816 is the “local processing” step of FIG. 8. Step 1130 ensues. Step 1130 determines if DA[0]=0xBE, which indicates that an SS (503) has received a unicast message addressed to itself. If so, then Step 1132 ensues; otherwise Step 1101 ensues.

Step 1132 determines if the message is a collective request frame (402), further described below. If so, then the SS (503) responds to collective request frames (402) per Step 1134, as described below. If not, then the SS (503) follows the Open Send process for an SS (503), as described below, beginning in Step 1136. In Step 1136, SS (503) validates the frame and determines whether to forward it to the collective. If so, in the subsequent Step 1138 the SS (503) changes the DA[0] of the frame from the unicast 0xBE to the multicast 0xBF. In the following Step 1140, the SS (503) forwards the modified frame via the egress port identified by port ID (103) value equal to DA[1], which holds the Pod ID p per the host AB (705) detailed in FIG. 7a.

In Step 1101, the switch determines whether the frame is a join frame (1002). In some embodiments, the switch examines the EtherType of the frame, which per standardization follows the source address of the frame and identifies a protocol. In some embodiments, a field following the EtherType, known as a subtype, further identifies the protocol. If, as a result of Step 1101, the frame is identified as a join frame (1002), Step 1102 ensues; otherwise, Step 1120 ensues.

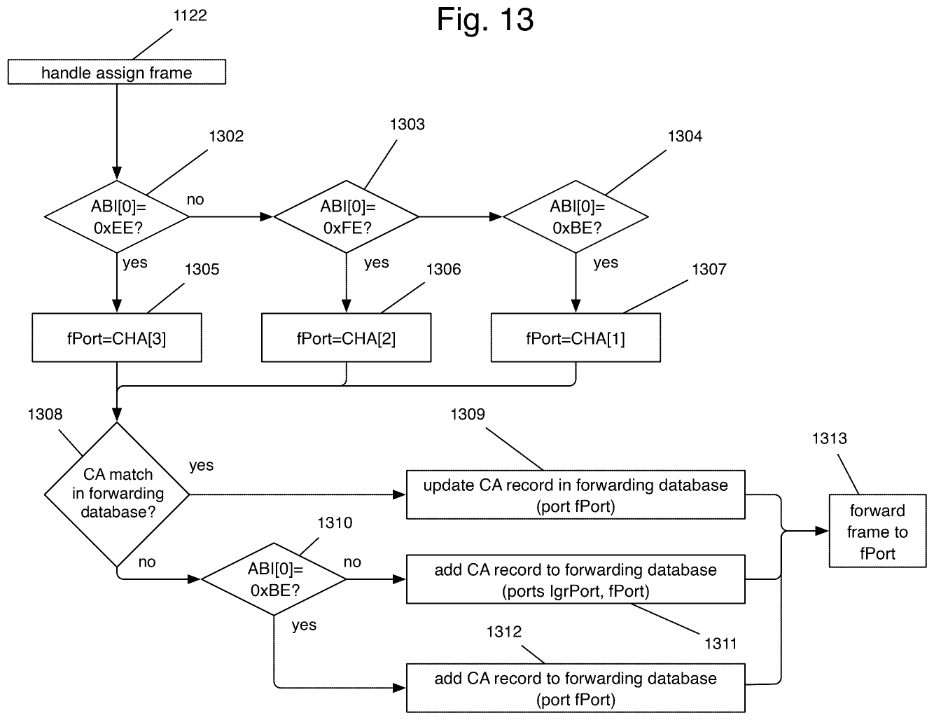

In Step 1120, the switch determines whether the frame is an assign frame; in some embodiments, this is based on EtherType and subtype, as in Step 1101. If so, then Step 1122 ensues, per FIG. 13 as described below. Otherwise, the switch takes actions unspecified herein.

In Step 1102, the switch compares the CAs of the CA set in the frame to the egress vector (110) records in forwarding database (106) to determine whether a TRUE frame condition (109) exists. If it exists, then Step 1103 ensues; otherwise, Step 1104 ensues.

In Step 1103, the switch updates the TRUE egress vector (110) record in forwarding database (106), adding the ingress port IgrPort to that egress vector (110). In some embodiments, Step 1110 ensues (with fPort as in Step 1107 for and RS and Step 1108 for an FS) so that the collective spine switch receives notice of the host; however, in other embodiments, the procedure terminates here since the subsequent switches are presumed to have been already configured by earlier join frames.

In Steps 1104 and 1105, the switch examines its ABI[0], which determines the switch level. In Step 1104, if ABI[0]=0xEE, then the switch is an RS (501) and Step 1107 ensues. In Step 1105, if ABI[0]=0xFE, then the switch is an FS (502) and Step 1108 ensues. Otherwise, the switch is presumed an SS (503) and Step 1106 ensues.

In Step 1107, the switch sets the variable fPort in memory (105) to CA[2]+k/2, indicating the port ID (103) of the port (202) toward the collective spine switch whose Spine ID (604) is indicated in CA[2]. Step 1109 ensues.

In Step 1108, the switch sets the variable fPort in memory (105) to CA[1]+k/2, indicating the port ID (103) of the port (202) toward the collective spine switch whose Spine Switch ID (605) is indicated in CA[1]. Step 1109 ensues.

In Step 1106, the switch, an SS (503), adds a record of the CA into forwarding database (106), indicating the ingress port IgrPort in the egress vector (110). If the join frame (1002) specified a CA set, the record may be specified to include the entire set.

In Step 1109, the switch, an RS (501) or FS (502), adds a record of the CA into forwarding database (106), indicating both the ingress port IgrPort and fPort in the egress vector (110). If the join frame (1002) specified a CA set, the record may be specified to include the entire set. Step 1110 ensues.

In Step 1110, the switch forwards the frame toward the collective spine switch, per the CA set. For an RS (501) or FS (502), this entails forwarding to fPort. For an SS (503), no action is taken.

In some embodiments, the spine switch responds to the requesting host, including, for example, a confirmation response, information about the collective, information about the host's order within the collective, etc. If join frame (1002) includes the quantity of members joining the collective, the spine switch may defer a response until it has received the identity quantity of join messages for the collective.

This completes the host-driven configuration of the Clos fat-tree flow-zone network to enable collective multicast, enabling the forwarding any frame from a member of the collective to each other member of the collective using the spanning tree through the collective spine switch.

### Spine-Assigned Clos Fat-Tree Collective Multicast

One restriction of host-driven collective multicast is that it relies on the hosts (201) to identify a CA or CA set prior to initiating the process. Even if they all make an identical choice, there is a possibility that a selected CA will be in use by another collective, leading to complications.

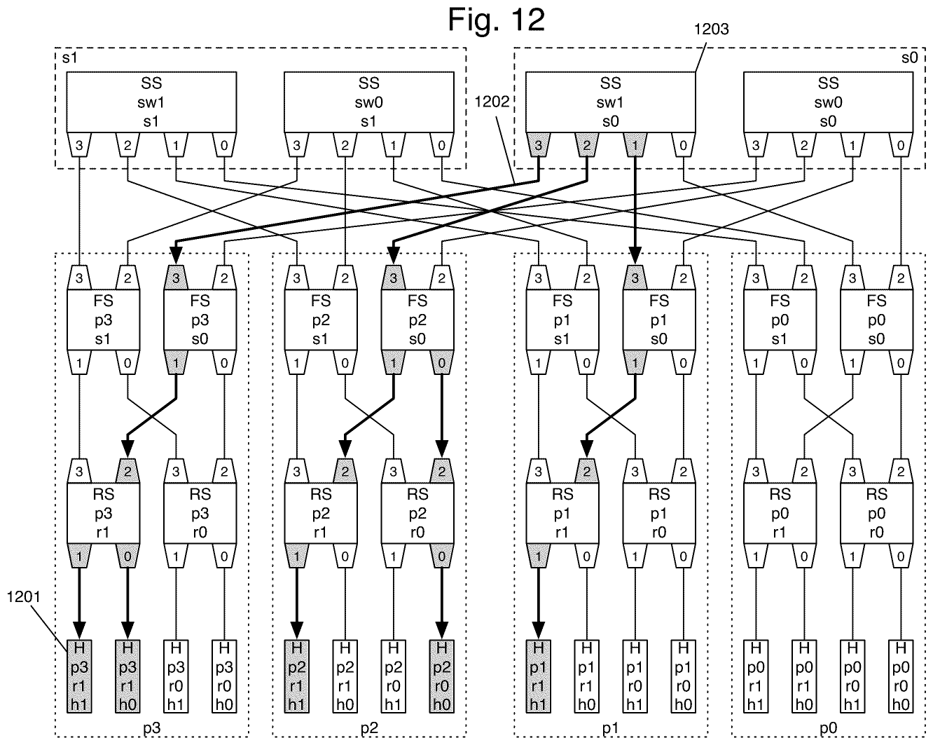

An alternative is spine-assigned collective multicast, aspects of which are illustrated in FIG. 12 and FIG. 13. At the start of that process, collective hosts (1201) interested in joining a common collective group each select a common CA spine switch (1203) (identified among the spine switches by the two bytes CA[1] and CA[2]) and a common join identifier. The join identifier is an identifier that is unlikely to be selected by another prospective collective; for example, it can be selected arbitrarily with a suitably large number of bits. In some embodiments, all collective hosts (1201) use an algorithm arranged so that they each select the same collective spine switch identifier and the same join identifier. In other embodiments, these values are provided by other means. The collective spine switch identifier and a join identifier are included in a collective request frame (402). In some embodiments, collective request frames (402) also specify the size of the CA set request; i.e., the quantity of CAs requested. In some embodiments, collective request frame (402) also include the quantity of members making the request with the common join identifier.

Each host sends a collective request frame (402) to the CA spine switch (1203). In some embodiments, this is achieved by sending collective request frame (402) to a unicast address for CA spine switch (1203) within SS address block (702). In some embodiments, that unicast address uses a custom format indicative of and specific to a collective request frame (402).

The CA spine switch (1203) receives and stores collective request frame (402) with a common join identifier and identifies them as collective request frame (402) for a common collective. In some embodiments, the collective spine switch may wait until all collective request frames (402) have been received; for example, based on the quantity of requests, if provided in the collective request frame (402).

In Step 1134, the CA spine switch (1203) selects, for the collective requested in the collective request frame (402), a CA set specifying one or more CAs, considering the quantity requested, from among those multicast addresses within its SS address block (702). For each such CA, CA[0]=0xBF, and CA[1] and CA[2] are the assigned Spine Switch ID (605) and Spine ID (604), respectively, of the CA spine switch (1203). The remaining values of CA are selected so as to avoid any that the CA spine switch (1203) has previously assigned and are currently active. The assignment stage of spine-assigned Clos fat-tree collective multicast follows, as illustrated in FIG. 12 and FIG. 13.

In this assignment stage, the collective spine switch creates a collective assignment frame (302), known as an assign frame (1202), for sending to a collective host (1201) providing information required to join the collective. The assign frame (1202) may be issued with a destination address set to the Nearest Customer Bridge (NCB) address or other scope-limited address of IEEE Std 802.1Q, with a proviso that switches along the route will forward the frame only via the port toward the collective host (1201). The proviso notifying the switch to examine the frame and forward it toward the collective host (1201) can be triggered by, for example, a distinctive EtherType and subtype.

The assign frame (1202) specifies the join identifier so that collective host (1201) will be enabled to match the assignment to the corresponding collective request frame (402). The assign frame (1202) specifies the CA set. The assign frame (1202) specifies the collective host address (CHA), which is the address of the collective host (1201). The CA spine switch (1203) may determine the CHA as the source address of the collective request frame (402) to which the assign frame responds.

In some embodiments, the assign frame (1202) specifies the quantity of members joining the collective. In some embodiments, the assign frame (1202) specifies the rank, or order, of the destination collective host (1201) within the collective. In some embodiments, the assign frame (1202) specifies the identifiers or members joining the collective.

The assign frame (1202), is some embodiments using the NCB address as the destination address, is forwarded in the network toward the collective host (1201), beginning with the collective spine switch itself. This is illustrated by the heavy arrows on some links in FIG. 12. The forwarding, and the configuration of the network that occurs in the switches as they receive and pass along the assign frames (1202), is explained as follows, with reference to FIG. 13.

FIG. 13 begins with Step 1122 of FIG. 11, in which the switch handling the frame with local processing has identified the frame as an assign frame (1202). Step 1302 ensues.

In Steps 1302-1304, the switch examines its ABI[0], which determines the switch level. In Step 1302, if ABI[0]=0xEE, then the switch is an RS (501) and Step 1305 ensues. In Step 1303, if ABI[0]-0xFE, then the switch is an FS (502) and Step 1306 ensues. In Step 1304, if ABI[0]=0xBE, then the switch is an SS (503) and Step 1307 ensues.

In Step 1305, the RS (501) sets the variable fPort in memory (105) to CHA[3], indicating the port ID (103) of the port (202) toward the CHA included in the assign frame (1202). Step 1308 ensues.

In Step 1306, the FS (502) sets the variable fPort in memory (105) to CHA[2], indicating the port ID (103) of the port (202) toward the CHA included in the assign frame (1202). Step 1308 ensues.

In Step 1307, the SS (503) sets the variable fPort in memory (105) to CHA[1], indicating the port ID (103) of the port (202) toward the CHA included in the assign frame (1202). Step 1308 ensues.

In Step 1308, the switch determines whether the CA set specified in the assign frame (1202) matches TRUE for any record in forwarding database (106). If so, then Step 1309 follows. If not, then Step 1310 follows.

Step 1310 is followed by Step 1312 if ABI[0]=0xBE (i.e., if the switch is an SS (503)) and by Step 1311 otherwise.

In Step 1309, the switch updates the record of the CA set in forwarding database (106), adding fPort to that record's egress vector (110) in not already set. Step 1313 ensues.

In Step 1311, the switch adds a record of the CA set in forwarding database (106), specifying fPort and the assign frame (1202)'s IgrPort in the egress vector (110). Step 1313 ensues.

In Step 1312, the switch adds a record of the CA set in forwarding database (106), specifying fPort in the egress vector (110). Step 1313 ensues.

In Step 1313, the switch forwards the frame via the port fPort.

After the assign frame (1202) is forwarded by RS (501) to its fPort per Step 1305, it is received the collective host (1201) identified in the CHA. The collective host (1201) matches the assign frame (1202) to its original collective request frame (402) based on a match of the join identifier in the collective request frame (402) and in the assign frame (1202). The collective host (1201) then adopts the received CA set as the set of CAs suitable for use in forwarding among the collective.

This completes the spine-assigned configuration of the Clos fat-tree flow-zone network to enable collective multicast, forwarding any frame from a member of the collective to each other member of the collective using the spanning tree through the collective spine switch.

### Open Send

As noted earlier, use of the “open send” model of multicast provides that the network is configured to deliver a message from any host that sends to a declared destination address.

Some embodiments support the “open send” model, providing that frames similar to CA frames are forwarded to the CA spine switch in unicast fashion and then forwarded to the collective. In some embodiments, such forwarding is subject to validation; e.g., by the CA spine switch. This allows any hosts to send nonmember frames to the CA spine switch, which may forward them to the CA.

In some embodiments, a nonmember transmits an Open Send frame by addressing it to a unicast DA that is identical to the CA except for the single bit that indicates unicast rather than multicast. In other words, the Open Send DA is identical to the corresponding CA except that DA[0]=0xBE, whereas CA[0]=0xBF.

Consequently, an Open Send frame is a unicast frame within the spine switch AB 702, per FIG. 7a. Therefore, the procedure of FIG. 8 (particularly beginning at Step 830) forwards the Open Send frame to the collective spine switch.

In some embodiments, the spine switch receiving the Open Send frame processes it per Steps 1136-1140 of FIG. 11. In Step 1136, SS (503) validates the frame and determines to forward it to the collective. In Step 1138, it changes DA[0] to 0xBF. In Step 1140, Step 819 of FIG. 8 ensues, initiating the forwarding of the modified data frame to the collective.

### Concluding Comments

Various embodiments of the invention have been described by way of example and with reference to the drawings. However, it should be realized that this is not an exhaustive description of all possible embodiments and that many other embodiments and variations fall within the scope of the appended claims, which can be realized by those persons having ordinary skill in the art.

This description is presented to enable any person skilled in the art to make and use the embodiments. All matter contained in the above description and shown in the accompanying drawings is to be interpreted as illustrative examples and not in a limiting sense. Various modifications to the disclosed embodiments will be readily apparent to those skilled in the art, and the general principles described herein are applicable to other embodiments and applications without departing from the spirit and scope of the present disclosure.

The quantity of entities shown in the drawings and tables are for exemplification purposes only and does not indicate any restriction regarding the actual number of such entities. The division of entities is for clarity and does demand separation of such entities.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks May sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed:

1. A data switch configured to operate in a network, configured with a plurality of ports and with a memory capable of storing, updating, and reading a plurality of egress vectors in an egress table, and configured to:
receive, at a first ingress port, a first collective assignment frame;
parse the first collective assignment frame to identify within it a first set of one or more collective addresses and a first delivery address;
determine a first egress port of the first collective assignment frame suitable for forwarding the first collective assignment frame toward the first delivery address;
store, in a first egress vector, an association of the first set of collective addresses to the first ingress port and to the first egress port;
receive, at a second ingress port, which may be identical to the first ingress port, a second collective assignment frame;
parse the second collective assignment frame to identify within it a second set of one or more collective addresses and a second delivery address;
determine a second egress port, which may be identical to the first egress port, of the second collective assignment frame suitable for forwarding the second collective assignment frame toward the second delivery address;
determine that the second set of collective addresses and first set of collective addresses are identical;
update the first egress vector in accordance with the second collective assignment frame;
receive a data frame;
determine that the destination address of the data frame is within the set of collective addresses in the first egress vector;
identify egress ports associated with the set of collective addresses in the first egress vector; and
forward the data frame to the identified egress ports, excluding the data frame's ingress port.

2. The switch of claim 1, wherein the update of the first egress vector in accordance with the second collective assignment frame comprises updating the first egress vector to include an association to the second ingress port, if different from the first ingress port.

3. The switch of claim 1, wherein the update of the first egress vector in accordance with the second collective assignment frame comprises updating the first egress vector to include an association to the second egress port, if different from the first egress port.

4. The switch of claim 1, wherein the first delivery address is implicitly determined from the first set of one or more collective addresses.

5. The switch of claim 1, wherein the first set of collective addresses is represented as an address block indicated by a field the same size, in bits, as the destination address of the data frame.

6. The switch of claim 1, wherein the network is a Clos fat tree.

7. The switch of claim 1, wherein the first and second collective assignment frames are Layer 2 frames.

8. A method of operating a data switch to forward collective multicast frames in a network, comprising:
configuring the switch with a plurality of ports and with a memory capable of storing, updating, and reading a plurality of egress vectors in an egress table;
receiving, at a first ingress port, a first collective assignment frame;
parsing the first collective assignment frame to identify within it a first set of one or more collective addresses and a first delivery address;
determining a first egress port of the first collective assignment frame suitable for forwarding the first collective assignment frame toward the first delivery address;
storing, in a first egress vector, an association of the first set of collective addresses to the first ingress port and to the first egress port;
receiving, at a second ingress port, which may be identical to the first ingress port, a second collective assignment frame;
parsing the second collective assignment frame to identify within it a second set of one or more collective addresses and a second delivery address;
determining a second egress port, which may be identical to the first egress port, of the second collective assignment frame suitable for forwarding the second collective assignment frame toward the second delivery address;
determining that the second set of collective addresses and first set of collective addresses are identical;
updating the first egress vector in accordance with the second collective assignment frame;
receiving a data frame;
determining that the destination address of the data frame is within the set of collective addresses in the first egress vector;
identifying egress ports associated with the set of collective addresses in the first egress vector; and
forwarding the data frame to the identified egress ports, excluding the data frame's ingress port.

9. The method of claim 8, wherein updating the first egress vector in accordance with the second collective assignment frame comprises updating the first egress vector to include an association to the second ingress port, if different from the first ingress port.

10. The method of claim 8, wherein updating the first egress vector in accordance with the second collective assignment frame comprises updating the first egress vector to include an association to the second egress port, if different from the first egress port.

11. The method of claim 8, wherein the first delivery address is implicitly determined from the first set of one or more collective addresses.

12. The method of claim 8, wherein the first set of collective addresses is represented as an address block indicated by a field the same size, in bits, as the destination address of the data frame.

13. The method of claim 8, wherein the network is a Clos fat tree.

14. The method of claim 8, wherein the first and second collective assignment frames are a Layer 2 frames.

15. A computer program product comprising a non-transitory computer-readable storage medium storing instructions that when executed by a data switch, configured with a plurality of ports and with a memory capable of storing, updating, and reading a plurality of egress vectors in an egress table, enable the switch to operate a method of forwarding collective multicast frames, comprising:
receiving, at a first ingress port, a first collective assignment frame;
parsing the first collective assignment frame to identify within it a first set of one or more collective addresses and a first delivery address;
determining a first egress port of the first collective assignment frame suitable for forwarding the first collective assignment frame toward the first delivery address;
storing, in a first egress vector, an association of the first set of collective addresses to the first ingress port and to the first egress port;
receiving, at a second ingress port, which may be identical to the first ingress port, a second collective assignment frame;
parsing the second collective assignment frame to identify within it a second set of one or more collective addresses and a second delivery address;
determining a second egress port, which may be identical to the first egress port, of the second collective assignment frame suitable for forwarding the second collective assignment frame toward the second delivery address;
determining that the second set of collective addresses and first set of collective addresses are identical;
updating the first egress vector in accordance with the second collective assignment frame;
receiving a data frame;
determining that the destination address of the data frame is within the set of collective addresses in the first egress vector;
identifying egress ports associated with the set of collective addresses in the first egress vector; and
forwarding the data frame to the identified egress ports, excluding the data frame's ingress port.

16. The computer program product of claim 15, wherein updating the first egress vector in accordance with the second collective assignment frame comprises updating the first egress vector to include an association to the second ingress port, if different from the first ingress port.

17. The computer program product of claim 15, wherein updating the first egress vector in accordance with the second collective assignment frame comprises updating the first egress vector to include an association to the second egress port, if different from the first egress port.

18. The computer program product of claim 15, wherein the first delivery address is implicitly determined from the first set of one or more collective addresses.

19. The computer program product of claim 15, wherein the first set of collective addresses is represented as an address block indicated by a field the same size, in bits, as the destination address of the data frame.

20. The computer program product of claim 15, wherein the network is a Clos fat tree.
